(19) United States
(12) Patent Application Publication
(10) Pub. No.: US 2009/0049015 A1
(43) Pub. Date: Feb. 19, 2009

(54) DATA MANAGEMENT DEVICE AND TERMINAL DEVICE

(75) Inventor: Nobuyuki Imanishi, Tokushima (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 12/090,809

(22) PCT Filed: Oct. 18, 2006
(86) PCT No.: PCT/JP2006/320783

§ 371 Date: Apr. 18, 2008

(30) Foreign Application Priority Data
Oct. 18, 2005 (JP) 2005-303769

(51) Int. Cl. G06F 17/30

(52) U.S. Cl. 707/3; 707/100; 707/E17.044; 707/E17.014

(57) ABSTRACT

A technique is provided for managing data with high efficiency.

In a management server, a file registration reception unit receives a file registration request from the user via a terminal apparatus. A definition information holding unit stores conditions under which the attribute information is assigned to a file according to a file registration request. An attribute assignment unit assigns the attribute information to the file based upon the conditions held by the definition conditions holding unit. A file registration unit stores the file uploaded from the user terminal in a specified folder in a file holding unit. Furthermore, the attribute assignment unit registers the attribute information with respect to the file in a file information database.

### TECHNICAL FIELD

The present invention relates to a data management technique, and particularly to a data management apparatus which manages data and a terminal apparatus which accesses data held by the data management apparatus.

### BACKGROUND ART

In recent years, every business has been promoting the use of information in electronic form in order to improve the efficiency of the business environment. The change in business management from paper-based management to systematic management based on electronic data has been anticipated to drastically improve the efficiency of the business environment.

### DISCLOSURE OF THE INVENTION

### Problem to be Solved by the Invention

However, in an arrangement in which a mass of information is stored in the form of electronic data, if the user is not permitted to reuse this information, it cannot be expected that such an arrangement will improve the efficiency of the business environment. In many companies, each department introduces its own system, and accordingly, the IT environment has been gradually improved. This leads to a difficulty in linking the data or sharing the information among the departments. In addition, it is not easy to find desired data within such data accumulated in an unsystematic manner. That is to say, important data is in danger of being buried within such a massive quantity of data.

The present invention has been made in view of such a situation. Accordingly, it is a general purpose of the present invention to provide a technique for effectively managing data.

### Means to Solve the Problem

In order to solve the aforementioned problem, a data management apparatus according to an embodiment of the present invention comprises: a reception unit which receives a data registration request; a condition holding unit which stores a condition under which attribute information is to be assigned to the data; an attribute assignment unit which assigns the attribute information to the data under the condition held by the condition holding unit; and a registration unit which stores the data in a data holding unit, and which registers the attribute information with respect to the data in a database.

The attribute information may include a common attribute which is to be assigned to all the files, and a customized attribute which can be assigned as desired. Also, an arrangement may be made in which the condition can be set in increments of directories stored in the data holding unit.

Also, the data management apparatus may further comprise: a form information reception unit which displays an input form including multiple data items in a predetermined format, and which receives data input via the input form; a form information registration unit which registers the data, thus input via the input form, in a form information database such that it is associated with the data items; and a form information search unit which receives a search condition with respect to the data items, and which extracts from the form information database the data matching the search condition.

Another embodiment of the present invention relates to a terminal apparatus. The terminal apparatus comprises: a tree display control unit which acquires information which defines a hierarchical structure for classifying, in a hierarchical manner, data stored in a data management apparatus which manages data, and displays the hierarchical structure thereof; and a list display control unit in which, when a node in the hierarchical structure is selected, a request is made to the data management apparatus to search for data included in a class that corresponds to the node so as to acquire search results, and the search results thus acquired are displayed in the form of a list.

Also, the list display control unit may acquire information from the data management apparatus with respect to multiple attributes assigned to the data included in the aforementioned class, may receive information with respect to two attributes selected according to an instruction from among the information with respect to the multiple attributes, and may display a map in which the data is plotted with the attribute information thus specified respectively set as a vertical axis and a horizontal axis. Also, the list display control unit may acquire information from the data management apparatus with respect to multiple attributes assigned to the data included in the aforementioned class, may receive the attribute information which is to be set as an index of a graph and which is selected according to an instruction from among the information with respect to the multiple attributes, and may display a graph in which the data is plotted with the attribute information thus specified set as the index. Also, the value or the count value of the attribute information thus specified may be set as the vertical axis or the horizontal axis of the map, or the index of the graph.

It should be noted that any combination of the aforementioned components or any manifestation of the present invention realized by modification of a method, apparatus, system, and so forth, is effective as an embodiment of the present invention.

### ADVANTAGE OF THE PRESENT INVENTION

The present invention provides a technique for managing data with high efficiency.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows a configuration of a data management system according to an embodiment;

FIG. 2 is a diagram which shows a configuration of a management server;

FIG. 3 is a diagram which shows an example of internal data stored in a definition file holding unit;

FIG. 4 is a diagram which shows an example of internal data stored in a file information database;

FIG. 5 is a diagram which shows an example of a form displayed on a user terminal by means of a form information reception unit, which allows data to be input;

FIG. 6 is a diagram which shows an example of internal data stored in a form information database;

FIG. 7 is a diagram which shows a configuration of the user terminal;

FIG. 8 is a diagram which shows an example of a display screen displayed by the user terminal;

FIG. 9 is a diagram which shows an example of the display screen displayed by the user terminal;

FIG. 10 is a diagram which shows an example of the display screen displayed by the user terminal;

FIG. 11 is a diagram which shows an example of the display screen displayed by the user terminal;

FIG. 12 is a diagram which shows an example of the display screen displayed by the user terminal;

FIG. 13 is a diagram which shows an example of the display screen displayed by the user terminal; and

FIG. 14 is a diagram which shows an example of the display screen displayed by the user terminal.

### DESCRIPTION OF THE REFERENCE NUMERALS

10 data management system, 30 management server, 32 file registration reception unit, 34 attribute assignment unit, 36 definition information holding unit, 38 file registration unit, 40 file holding unit, 42 file information database, 44 file search unit, 50 form information reception unit, 52 template holding unit, 54 form information registration unit, 56 form information database, 58 form information search unit, 60 user terminal, 62 tree display control unit, 64 list display control unit, 66 viewer control unit, 70 directory tree display unit, 71 taxonomy tree display unit, 72 search request reception unit, 73 list display unit, 74 map display unit, 75 graph display unit, 76 document display unit, 77 attribute display unit, 78 relation display unit

### BEST MODE FOR CARRYING OUT THE INVENTION

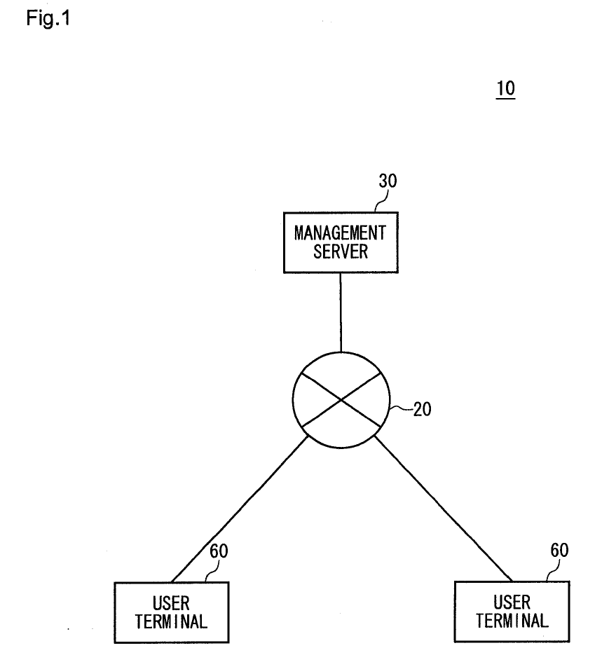

FIG. 1 shows a configuration of a data management system 10 according to an embodiment. In the data management system 10, a management server 30 which stores and manages files and a user terminal 60 are connected to a LAN 20 which is an example of a network. Description will be made in the present embodiment regarding a server-client model. Also, the technique according to the present invention can be applied to a standalone model.

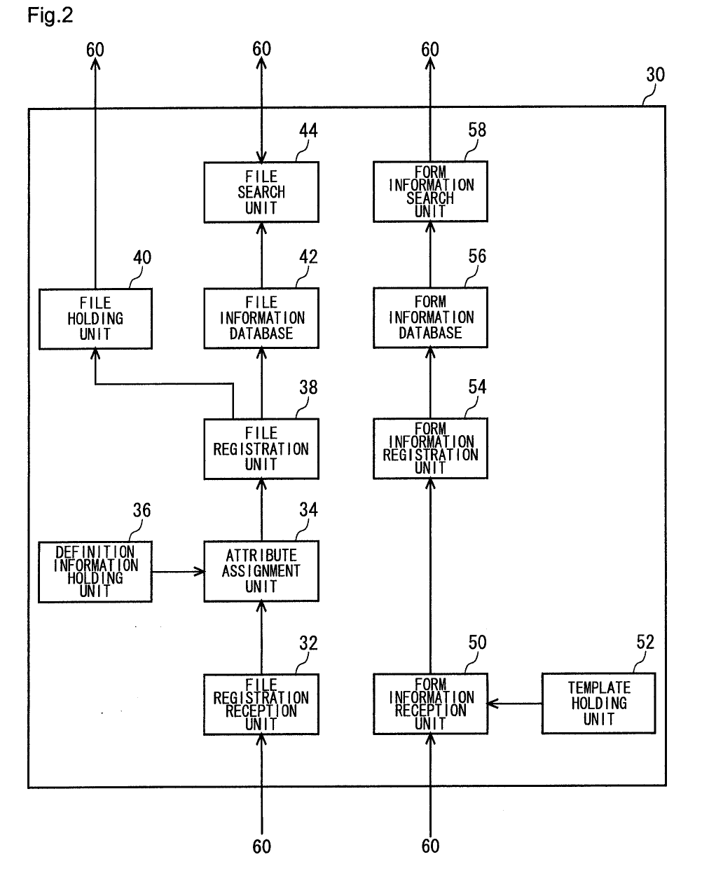

FIG. 2 shows a configuration of the management server 30. The management server 30 includes a file registration reception unit 32, an attribute assignment unit 34, a definition information holding unit 36, a file registration unit 38, a file information database 42, a file holding unit 40, a file search unit 44, a form information reception unit 50, a template holding unit 52, a form information registration unit 54, a form information database 56, and a form information search unit 58. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it would be understood by those skilled in the art that these function blocks can be realized in a variety of forms by hardware only, software only or the combination thereof.

The file registration reception unit 32 allows a file registration request to be received via the user terminal 60. In this stage, the file registration reception unit 32 receives the information which specifies the folder in which a file is to be stored. The attribute assignment unit 34 automatically assigns the attribute information to the file according to the registration request. The attribute information can be classified into common attributes and customized attributes. Here, the system automatically assigns these common attributes including, for example, the file creation date and time, to all the files at the system level, which are assigned to the files by the operating system. On the other hand, the data management system 10 allows the user to freely set the customized attributes. The definition information holding unit 36 stores the definition information beforehand, which specifies the conditions under which the customized attributes are to be assigned to the file. The attribute assignment unit 34 assigns the attributes to the file with reference to the definition conditions stored in the definition information holding unit 36.

The definition information may be set in increments of folders in which files are stored. For example, if a folder has been set to be a folder in which business reports are stored, the definition information holding unit 36 stores the definition information whereby an attribute that represents the file type, i.e., the “business report” attribute, is assigned to files stored in this folder.

The definition information may further include settings for performing other processing, examples of which include data format conversion, file name replacement, etc. With such an arrangement, the management server 30 further includes an execution unit which executes the processing according to the settings stored in the definition information holding unit 36. Upon reception of a file registration request, the execution unit executes processing on a file which is to be registered according to the settings stored in the definition information holding unit 36.

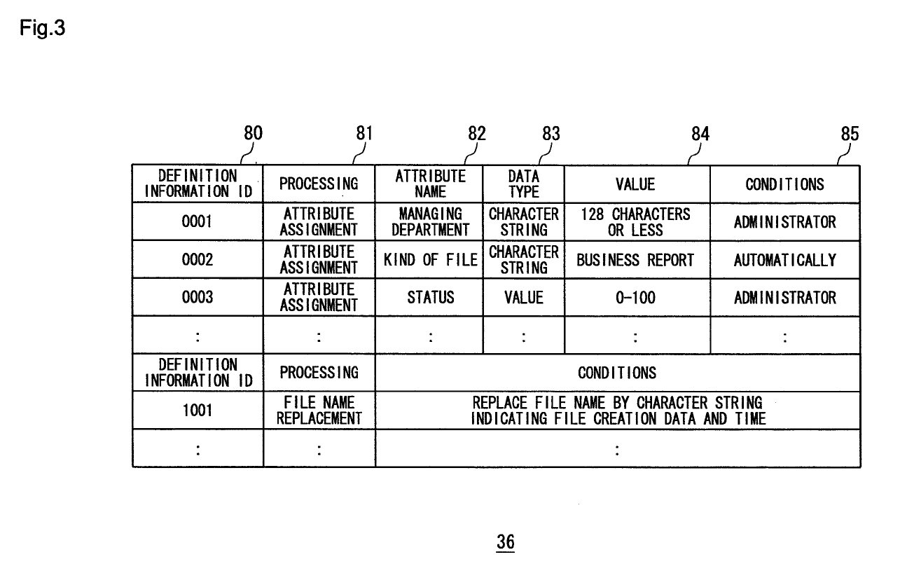

FIG. 3 shows an example of internal data stored in the definition information holding unit 36. The definition file holding unit 36 includes a definition file ID field 80, a processing field 81, an attribute name field 82, a data format field 83, a value field 84, and a conditions field 85. The definition information ID field 80 stores the ID which allows the definition information to be identified. The processing field 81 stores the content of the processing defined with reference to the definition information, examples of which include “attribute assignment”, “file name replacement”, “file format conversion”, etc.

For the content of the processing “attribute assignment”, the attribute name field 82 stores the name of the customized attribute, the data format field 83 stores the data format, the value field 84 stores the value range, and the conditions field 85 stores the conditions under which the attribute is to be assigned. FIG. 3 shows an example of the definition information set for the folder in which the business reports are stored. In this example, the attributes such as “management department”, “file type”, “status”, etc. are assigned to the file. Such an arrangement allows the “administrator” to set a character string of 128 characters or less for the “management department” attribute. Furthermore, such an arrangement automatically sets “business report”, which is a character string, for the “file type” attribute. Moreover, such an arrangement allows the administrator to set a value ranging from 0 to 100 for the “status” attribute. When the file registration reception unit 32 receives a request to register a file in this folder, the attribute assignment unit 34 sets the “file type” attribute to be “business report”. Furthermore, the attribute assignment unit 34 displays a dialog screen which allows the administrator to input a character string to be set for the “management department” attribute, and to input a value to be set for the “status” attribute. When the administrator inputs the value, the attribute assignment unit 34 determines whether or not the input value is within the range set in the value field 84. If the input value is within the range specified in the value field 84, the attribute assignment unit 34 receives the input value as the attribute information.

For the content of the processing other than the “attribute assignment”, the conditions field 85 stores the conditions under which the processing is to be executed. In the example shown in FIG. 3, settings are made for executing processing for replacing the file name with a numeric character string which represents the file creation date and time. When the file registration reception unit 32 receives a request to register a file in this folder, the execution unit acquires the file creation date and time, and executes the processing for replacing the file name with a numeric character string which represents the date and time of creation of the file.

The file registration reception unit 32 stores a file uploaded via the user terminal 60 in a specified folder in the file holding unit 40. Furthermore, the file registration unit 32 registers the attribution information with respect to the file in the file information database 42.

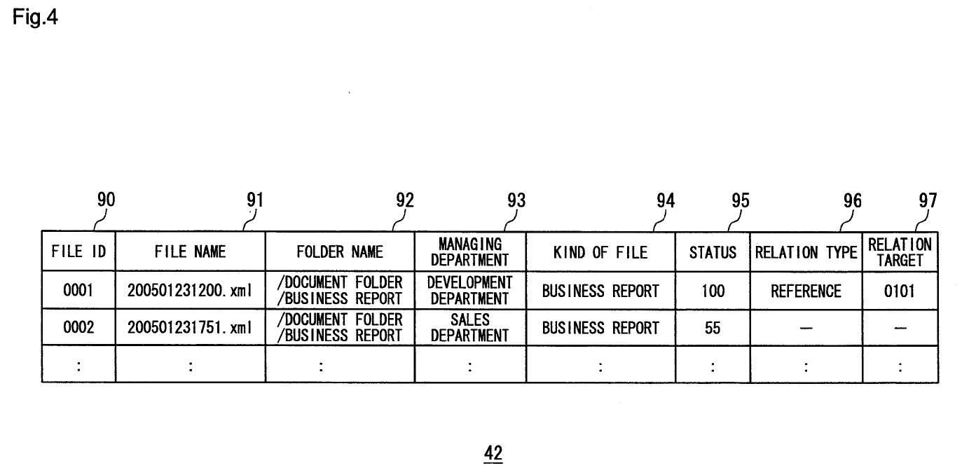

FIG. 4 shows an example of internal data stored in the file information database 42. The file information database 42 includes a file ID field 90, a file name field 91, a folder name field 92, a management department field 93, a file type field 94, a status field 95, a relation type field 96, and a relation target field 97. The file ID field 90 stores the ID of the file thus registered. The file name field 91 stores the file name of the registered file. The folder name field 92 stores the folder name of the folder in which the file has been registered. Here, the file name and the folder name are examples of the common file attributes. In addition, the file information database 42 may store other common attributes such as the file creation date and time, the access date and time, the latest update date and time, the file creator name, the file access user name, the latest user to update the file, the file extension, the file size, the name of the application used to create the file, etc. Each of the management department field 93, the file type field 94, and the status field 95 stores a value of the corresponding customized attribute applied to the file by the attribute assignment unit 34. The relation type field 96 stores the information which indicates the type of relation between the files as described later. The relation target field 97 stores the file ID of the file which represents the target of the file relation. Examples of relations between the files include a reference relation, a quotation relation, etc. Also, an arrangement may be made which permits the user to set a user's own file relation. Also, such an arrangement may allow multiple files to be registered as file relation targets.

The file search unit 44 searches the file information database 42 based upon the search conditions received via the user terminal 60 so as to extract files for which the attribute information matches the search conditions. The file search unit 44 transmits the attribute information with respect to the files thus extracted to the user terminal 60 as the search results. In the file registration step, the present embodiment allows the user to set and assign his/her own customized attributes in the file information database 42 so as to register a file, thereby allowing the user to search the files using the customized attributes. This improves the search efficiency, thereby enabling a large number of files to be efficiently managed.

The form information reception unit 50 displays on the user terminal 60 a data input form having multiple data items which allow the user to input data. The template holding unit 52 stores a template for the data input form. The form information reception unit 50 reads out the template for the form from the template holding unit 52, and displays the template thus read out on the user terminal 60, which allows the user to input data in a predetermined format. The form information registration unit 54 registers in the form information database 56 the data received by the form information reception unit 50. The form information database 56 may store the form information in the form of an XML document. The form information search unit 58 searches the form information database 56 based upon the search conditions received via the user terminal 60 so as to extract the data that matches the search conditions. The form information search unit 58 transmits the data thus extracted to the user terminal 60 as the search results. With such an arrangement, the data is stored using a form, thereby storing input data in a predetermined format. Such an arrangement improves the efficiency of the registration and search operation, thereby improving the ease-of-use for the user.

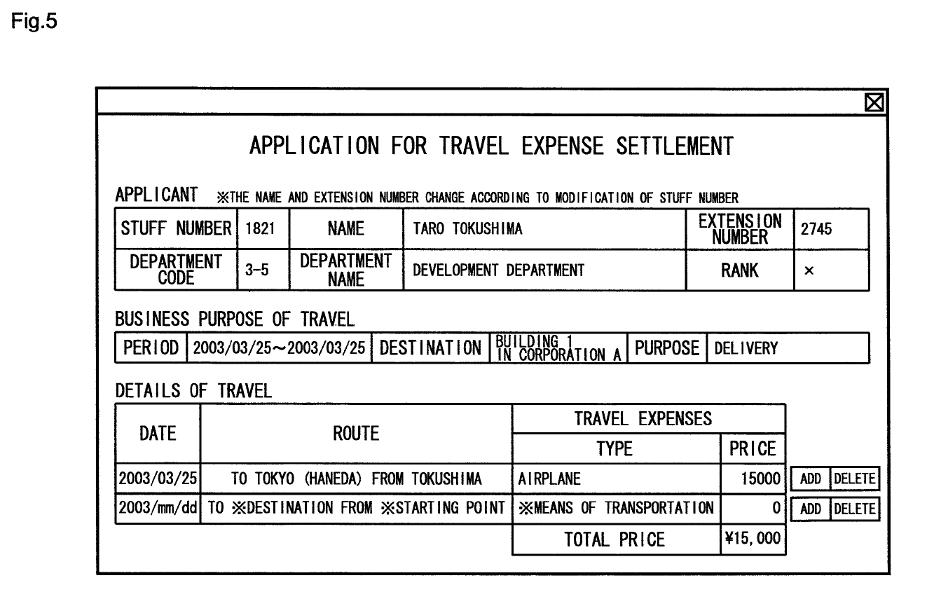

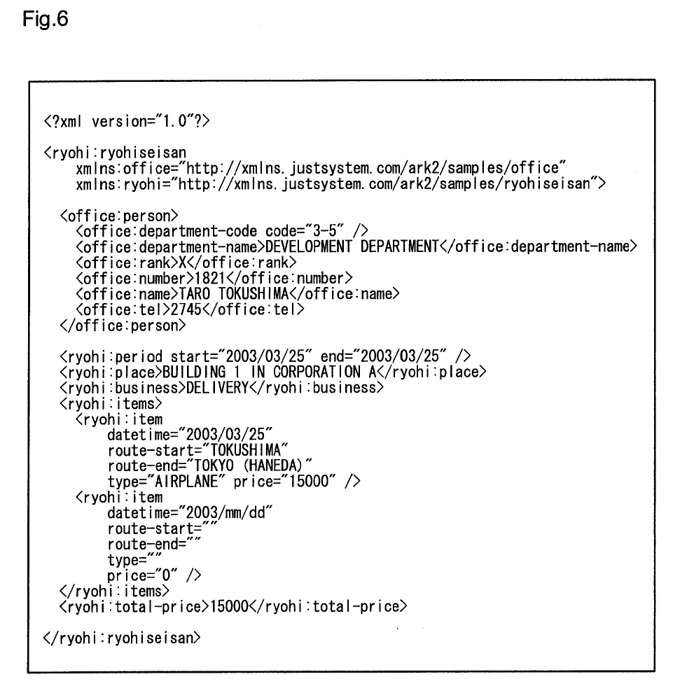

FIG. 5 shows an example of the data input form displayed on the user terminal 60 according to an instruction from the form information reception unit 50. Specifically, FIG. 5 shows an example of a form for making an application for travel expenses for business travel. Upon the user inputting the required items such as the staff number, the travel period, the travel destination, the business purpose of the travel, the date, the route of the business travel, and the travel expenses, the form information registration unit 54 registers the data thus input in the form information database 56. FIG. 6 shows an example of internal data stored in the form information database 56. In the example shown in FIG. 6, the data input via the form shown in FIG. 5 is stored in the form of an XML document.

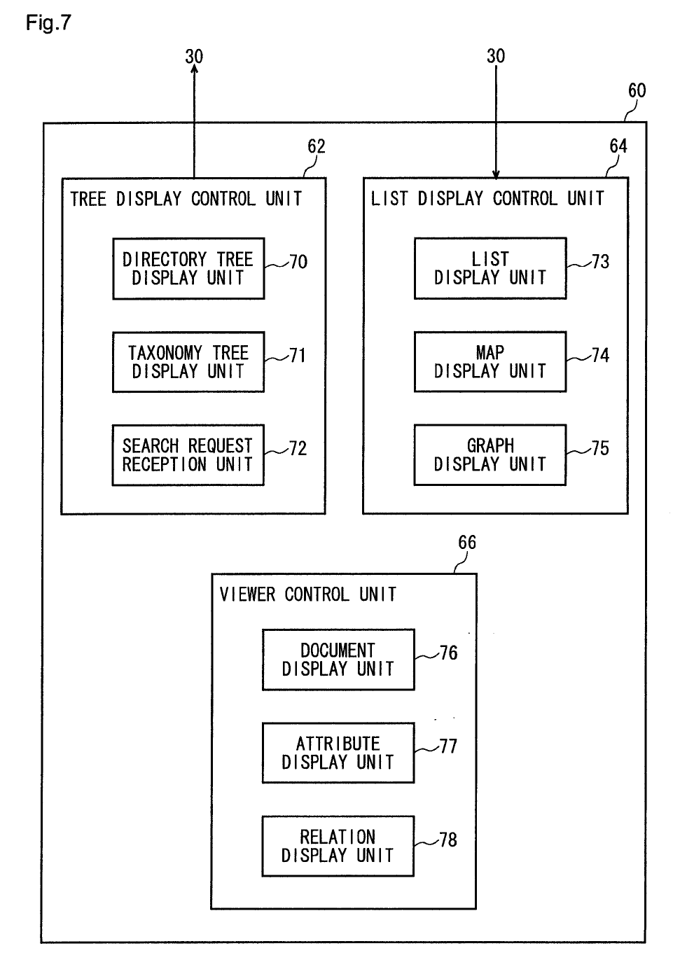

FIG. 7 shows a configuration of the user terminal 60. The user terminal 60 includes a tree display control unit 62, a list display control unit 64, and a viewer control unit 66. The tree display control unit 62 includes a directory tree display unit 70, a taxonomy tree display unit 71, and a search request reception unit 72. The list display control unit 64 includes a list display unit 73, a map display unit 74, and a graph display unit 75. The viewer control unit 66 includes a document display unit 76, an attribute display unit 77, and a relation display unit 78. These functional blocks can also be realized in a variety of forms by hardware only, software only or the combination thereof.

The tree display control unit 62 displays, in a tree display region on the display screen, any one of a directory tree, a taxonomy tree, and an interface which allows the user to input a search request. The directory tree display unit 70 displays in a tree format the directory structure stored in the file holding unit 40. The list display control unit 64 displays in the list display region the list of the files stored in a folder which has been selected via the directory tree. With such an arrangement, the user can register a file in the management server 30 by dropping an icon that represents a file on a folder in the directory tree. Upon reception of this operation, the directory tree display unit 70 makes a request to the management server 30 to register the file thus dropped. In this step, the management server 30 is notified that the folder on which the file has been dropped is the folder in which the file is to be registered.

The taxonomy tree display unit 71 displays a taxonomy tree which classifies the files stored in the file holding unit 40 based upon various kinds of attributes, and displays these files in a hierarchical and systematic manner. Such an arrangement allows the user to set a search expression or a file attribute for each of the nodes of the taxonomy tree which represent the respective levels thereof, thereby allowing the user to extract the files based upon such conditions. With such an arrangement, the files are managed in a systematic and hierarchical manner that differs from the physical hierarchical structure employed in the file holding unit 40. Furthermore, the data management system 10 according to the present embodiment allows the user to classify the files based upon the user's own customized attribute as desired. This allows the user to classify the files in various kinds of formats and in a more flexible manner, thereby allowing the user to classify and manage the information with high efficiency.

The definition information with respect to the hierarchical structure of the taxonomy tree may be stored in the user terminal 60. Also, such information may be stored in the management server 30. With the latter arrangement, the taxonomy tree may be shared among multiple users. When the user selects a node, the taxonomy tree display unit 71 acquires the search conditions for the parent nodes and the currently selected node in descending order of node parent/child relations, and makes a request to the management server 30 for a list of files that match the currently selected node. Then, the list display control unit 64 displays in a list display region the search results obtained for the search conditions set in the selected node in the taxonomy tree.

The search request reception unit 72 receives the search conditions such as file attributes, keywords, and natural language input which allows the user to make a conceptual search. The search request reception unit 72 transmits the search conditions thus received to the management server 30, which thus makes a search request to the management server 30. Then, the list display control unit 64 displays in the list display region the search results transmitted from the management server 30.

The list display unit 73 displays, in the list display region in the form of a list, the files included in the folder or the node currently selected in the tree display region, or the files that match the search conditions. The list display unit 73 acquires from the management server 30 the attributes of the files to be displayed in the form of a list, and displays the attributes in the form of a list according to the item settings.

When the map display unit 74 receives the settings of the vertical axis and the horizontal axis with respect to the attributes of the files to be displayed in the form of a list, the map display unit 74 displays these files in the form of a map with the attributes thus specified set as the vertical axis and the horizontal axis. The map display unit 74 may set the value of the specified attribute information as the vertical axis or the horizontal axis. Also, the map display unit 74 may set the count value as the vertical axis or the horizontal axis. The settings of the horizontal axis and the vertical axis with respect to the file attributes can be classified into three pattern settings, i.e., kind/kind settings; kind/value settings, and value/value settings. For example, such an arrangement allows the user to display the file creation history in increments of file creators in the form of a map with the file creator set as the horizontal axis and the file creation date set as the vertical axis. Also, such an arrangement allows the user to display the relation between the file creator and the number of files in the form of a map in increments of file creators and in increments of file types with the file creator set as the horizontal axis and the file type set as the vertical axis. Also, an arrangement may be made in which each dot that represents files for which the attributes match the matching conditions is plotted in the map with the color or size of the dot determined according to the number of files. For example, such dots may be plotted such that the color depth thereof increases according to the number of files.

When the graph display unit 75 receives the graph indexes with respect to the file attributes, the graph display unit 75 displays a graph in which the specified attributes are set as the respective indexes. The graph display unit 75 may set the graph index to be the value of the attribute information thus specified. Also, the graph display unit 75 may set the graph index to be the count value. For example, such an arrangement allows the user to display a circle graph using the number of files classified based upon the file creator name as an index. Also, such an arrangement allows the user to display a line graph using the number of files classified based upon the file creation date as an index. With such an arrangement, a bar graph may be created in which the length of each bar is adjusted according to the number of files that match the attribute conditions. Also, a circle graph may be created in which each area is adjusted according to the number of files that match the attribute conditions.

Such functions display the file attributes, information trends, etc., in a visually easy-to-understand manner, thereby contributing to the user's ability to find information.

The document display unit 76 displays the document text of the file selected by the list display control unit 64. The attribute display unit 77 displays the attribute information thus selected. The relation display unit 78 displays the relation between the file thus selected and the target file associated with the selected file.

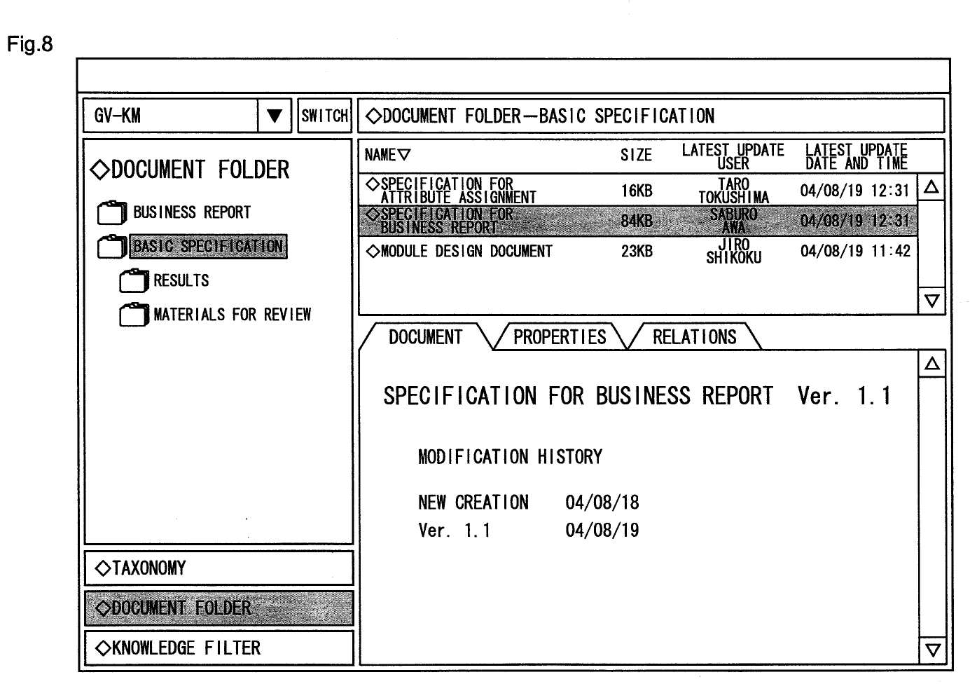

FIG. 8 shows an example of a display screen displayed by the user terminal 60. On the left side of the display screen, the tree display control unit 62 displays a tree display screen. On the upper-right side of the screen, the list display control unit 64 displays a list display screen. On the lower-right side of the screen, the viewer display unit 66 displays the information with respect to the file. In the example shown in FIG. 8, on the tree display screen, the directory tree display unit 70 displays the directory tree stored in the file holding unit 40. The directory tree display unit 70 makes a request to the management server 30 to acquire the directory tree, and displays the directory tree thus acquired from the file holding unit 40 on the tree display screen. Furthermore, on the list display screen, the list display unit 73 displays the list of files included in the folder thus selected via the directory tree displayed on the tree display screen. The list display unit 73 makes a request to the management server 30 to acquire the list of files included in the selected folder, and displays the list of files thus acquired from the file holding unit 40 on the list display screen. Moreover, on the viewer screen, the document display unit 76 displays the content of a file selected via the list display screen. The document display unit 76 makes a request to the management server 30 to acquire the file thus selected, and displays the content of the file thus acquired from the file holding unit 40 on the viewer screen. Also, an arrangement may be made in which the document display unit 76 edits the file according to an editing instruction made by the user via the viewer screen.

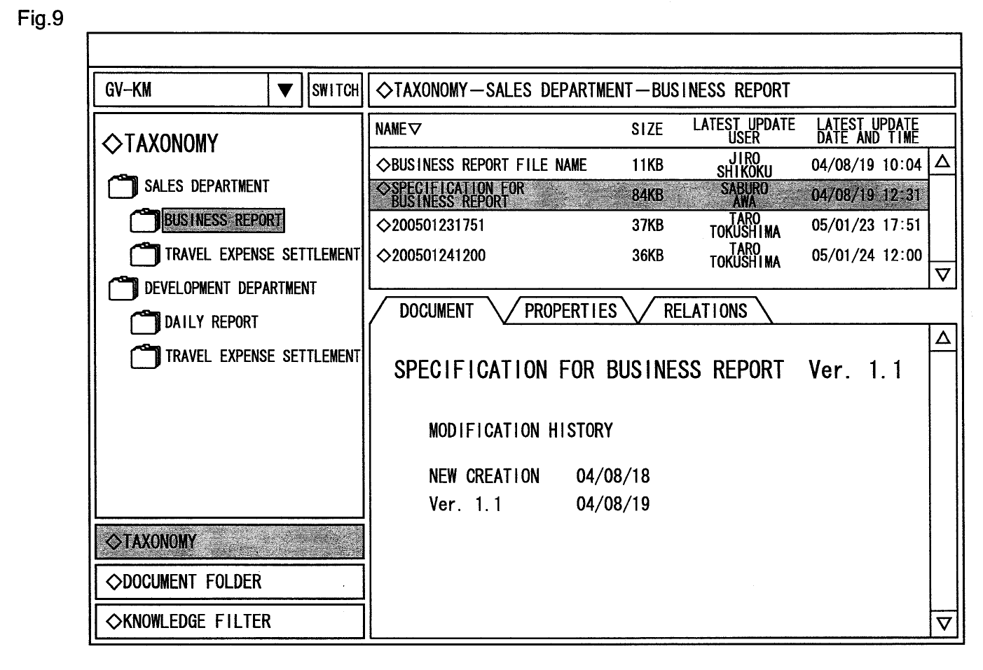

FIG. 9 shows an example of the display screen displayed by the user terminal 60. In the example shown in FIG. 9, on the tree display screen, the taxonomy tree display unit 71 displays a taxonomy tree. The taxonomy tree display unit 71 receives beforehand from the user the taxonomy tree structure and the extraction conditions set for each of the nodes that form the taxonomy tree, and holds this information thus received. When a request to display the taxonomy tree is received, the taxonomy tree display unit 71 displays on the tree display screen the tree structure of the taxonomy tree thus set and held beforehand. When the user selects a node on the tree display screen, the list display unit 73 displays on the list display screen the list of files that match the extraction conditions thus set for the node thus selected. The list display unit 73 notifies the management server 30 of the extraction conditions such as search expressions, file attributes, etc., thus set for the selected node, and makes a file search request to the management server 30. The file search unit 44 extracts with reference to the file information database 42 the files that match the extraction conditions thus received as a notice, and transmits the search results to the user terminal 60. The list display unit 73 displays on the list display screen the list of files thus acquired from the file search unit 44. In a case in which the selected node is a descendant node of any one of the other nodes, the list display unit 73 transmits to the management server 30 a notice of the extraction conditions set for the ancestor nodes of the selected node, in addition to the extraction conditions for the selected node. In this case, the list display unit 73 displays on the list display screen the list of files that match all the extraction conditions.

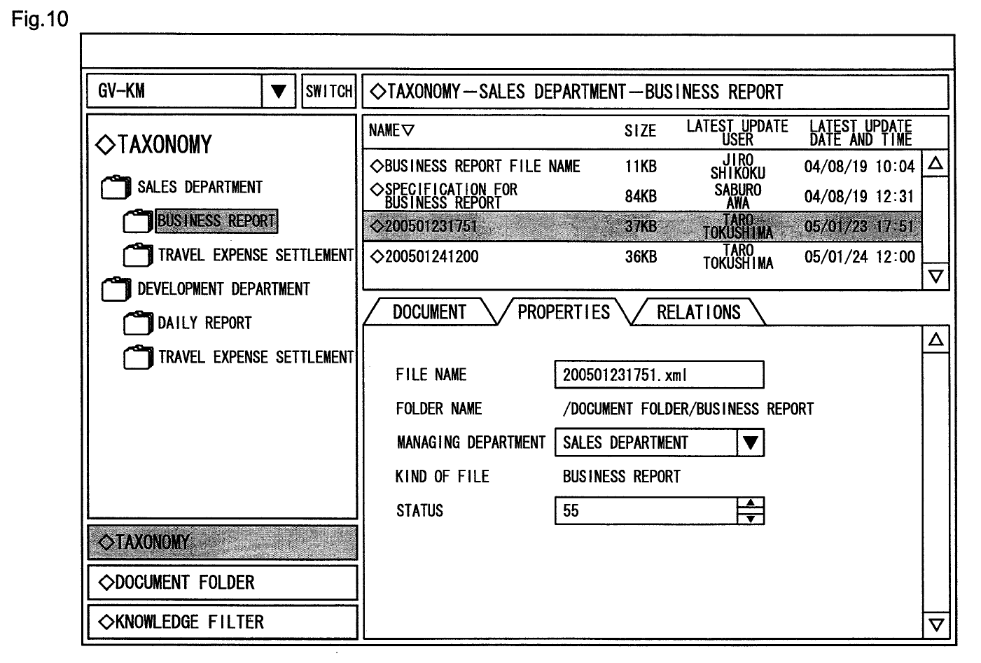

FIG. 10 shows an example of a display screen displayed by the user terminal 60. In the example shown in FIG. 10, on the viewer screen, the attribute display unit 77 displays the attribute information which has been assigned to the file selected via the list display screen. The attribute display unit 77 makes a request to the management server 30 to acquire the attribute information with respect to the file thus selected. The file search unit 44 reads out the file attribute information from the file information database 42 according to the request, and transmits the search results to the user terminal 60. The attribute display unit 77 displays on the viewer screen the file attribute information with respect to the file acquired from the file search unit 44. Also, the attribute display unit 77 may make a request to the management server 30 to change the file attribute information according to an editing instruction made by the user via the viewer screen.

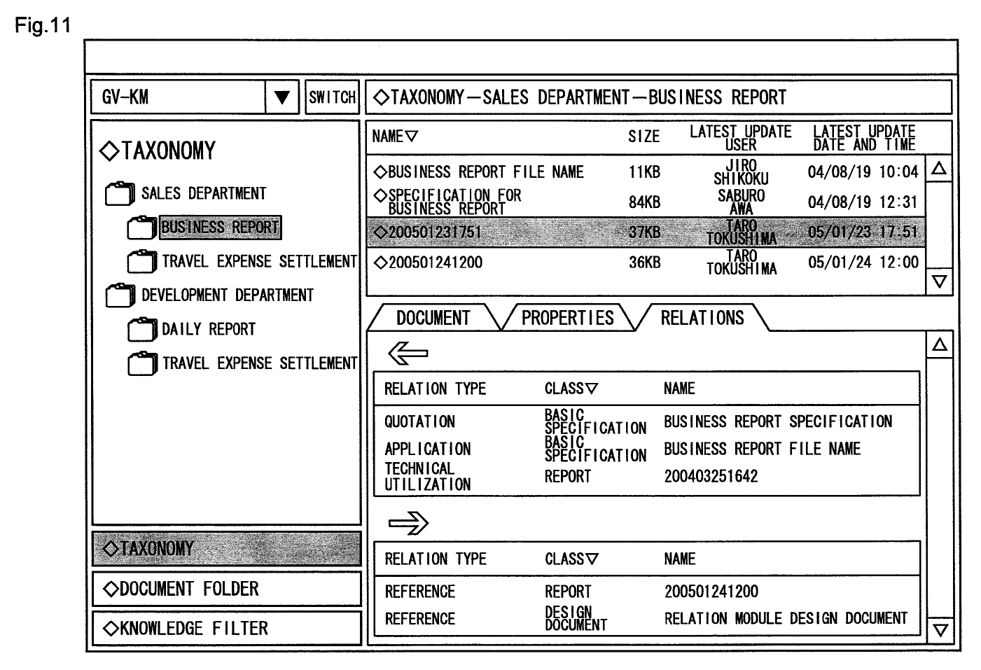

FIG. 11 shows an example of the display screen displayed by the user terminal 60. In the example shown in FIG. 11, on the viewer screen, the relation display unit 78 displays the information with respect to the files associated with the file selected via the list display screen. The relation display unit 78 makes a request to the management server 30 to acquire the information with respect to the file relation set for the selected file. The file search unit 44 reads out from the file information database 42 the information with respect to the relation set for the file according to the request notice, and transmits the search results thus read out to the user terminal 60. Specifically, the file search unit 44 reads out from the file information database 42 the information stored in the relation type field 96 and the relation target field 97, and transmits the search results thus read out to the user terminal 60. The relation display unit 78 displays on the viewer screen the information with respect to the file relation acquired from the file search unit 44. In the example shown in FIG. 11, the information set thus displayed includes: the information with respect to the relations set for different files with respect to the selected file; and the information with respect to the relation set for the selected file with respect to each of the other different files. Also, the relation display unit 78 may make a request to the management server 30 to change the information with respect to the file relation according to an instruction from the user via the viewer screen to edit the information with respect to the file relation. For example, an arrangement may be made which allows the user to set the relation between the files by dragging and dropping a different file on the viewer screen. Also, an arrangement may be made in which, when the user drops a file, the relation display unit 78 displays a dialog screen which allows the user to set the information with respect to the file relation such as the file relation type, the relation direction, etc. With such an arrangement, upon reception of the information, the relation display unit 78 notifies the management server 30 of the information thus received, and makes a request to register the information in the file information database 42.

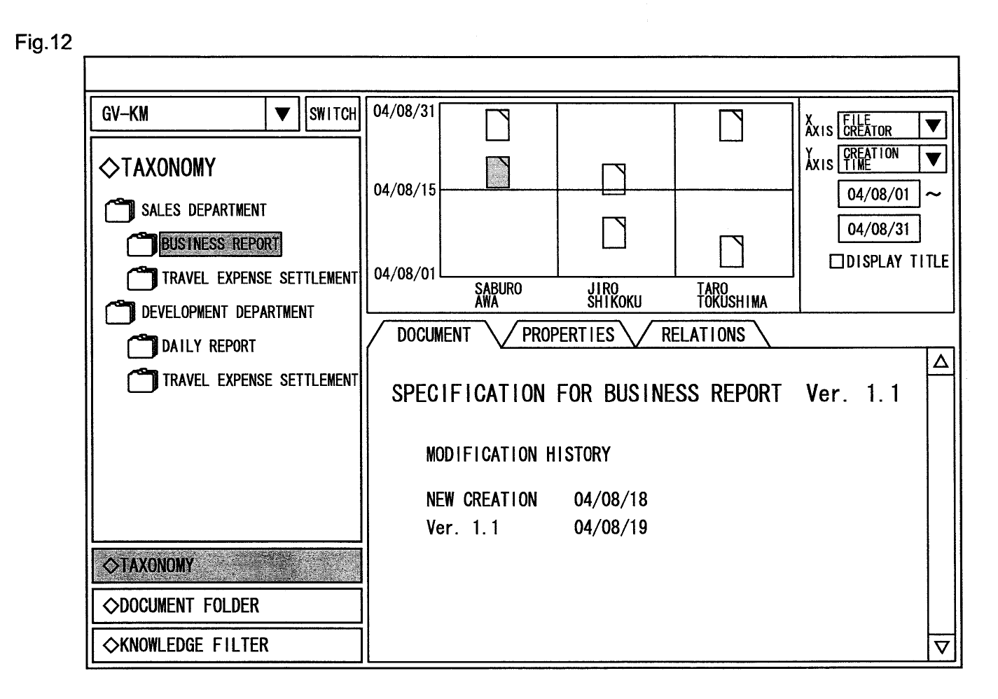

FIG. 12 shows an example of the display screen displayed by the user terminal 60. In the example shown in FIG. 12, on the list display screen, the map display unit 74 displays a map screen in which the files included in the folder or the node selected via the tree display screen are displayed with the specified attributes set as the vertical axis and the horizontal axis. In a case in which the attribute information with respect to the files included in the folder or the node has already been acquired from the management server 30, the map display unit 74 creates a map screen with reference to the information thus acquired. On the other hand, in a case in which the file attribute information has not been acquired, the map display unit 74 makes a request to the management server 30 to acquire the attribute information with respect to the files included in the folder or the node. In the example shown in FIG. 12, a map screen is displayed with the “file creator” attribute set as the horizontal axis, and with the “file creation date” attribute set as the vertical axis. Furthermore, a setting screen is displayed on the right side of the map screen, which allows the user to set the attributes for the horizontal axis and the vertical axis. The map display unit 74 displays a map screen in which the files are displayed according to the conditions thus input via the setting screen.

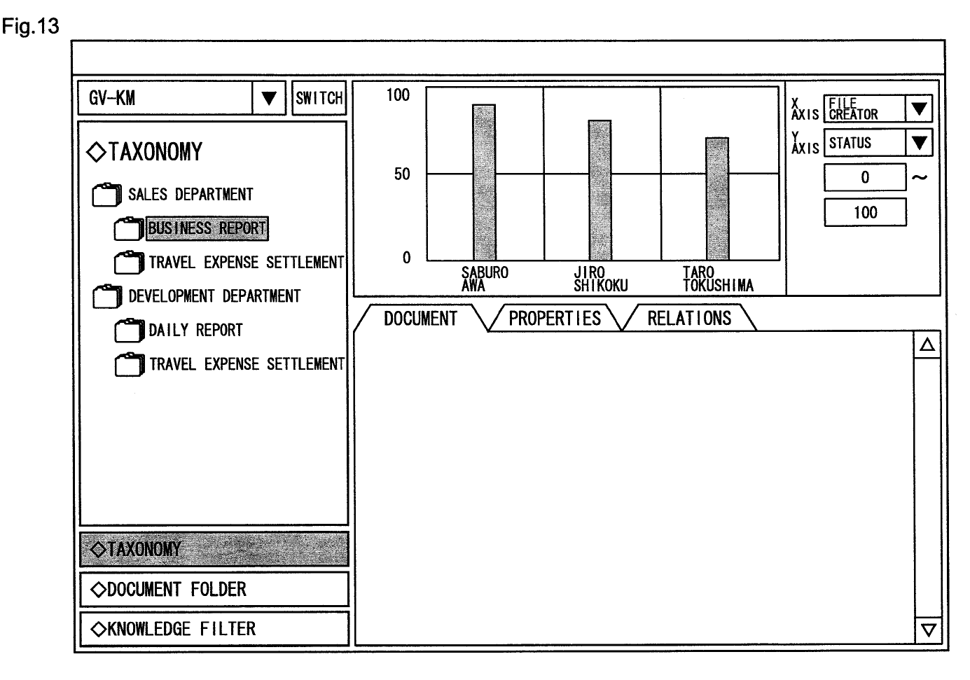

FIG. 13 shows an example of the display screen displayed by the user terminal 60. In the example shown in FIG. 13, the attributes are selected from among those with respect to the files included in the folder or the node selected via the tree display screen, and a graph is displayed on the list display screen by the graph display unit 75 with the attributes thus selected set as the indexes. In a case in which the file attribute information has not been acquired, the graph display unit 75 makes a request to the management server 30 to acquire the attribute information with respect to the files included in the folder or the node. In the example shown in FIG. 13, a graph is displayed with the “file creator” attribute set as the horizontal axis, and with the “status” attribute set as the vertical axis. On the right side of the graph, a setting screen is displayed, which allows the user to set the respective attributes for the horizontal axis and the vertical axis. The graph display unit 75 creates a graph with the file attribute information set as the indexes according to the conditions input via the setting screen.

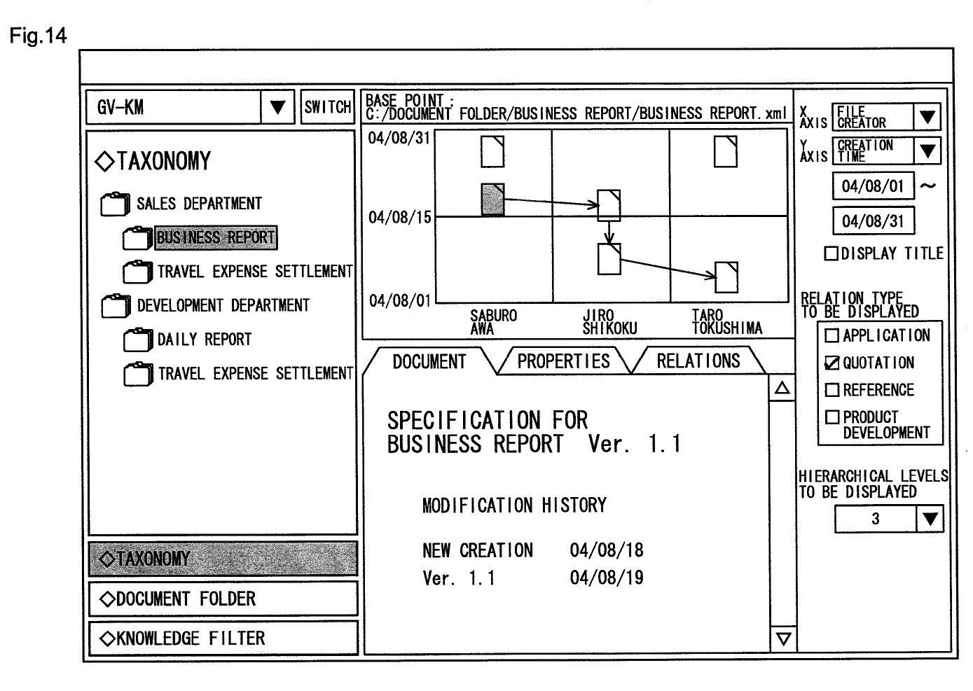

FIG. 14 shows an example of the display screen displayed by the user terminal 60. In the example shown in FIG. 14, on the list display screen, the map display unit 74 displays a map screen in which the files are mapped. With such an arrangement, the relation display unit 78 displays “arrow” symbols on the map screen, each of which indicates the relation between the files displayed on the map screen. In the example shown in FIG. 14, the arrow symbols are displayed, each of which indicates a corresponding file that has been set to have a “quotation relation” with respect to the selected file, in a range of the three hierarchical levels. The relation display unit 78 may display the arrow symbols in respective colors or thicknesses according to the type of relation. With such an arrangement, files that are directly or indirectly associated with each other are displayed with respect to a particular file as a base point in a visually easy-to-understand manner, thereby drastically improving the convenience for the user. Also, the relation display unit 78 may allow the user to make the file relation settings by dragging and dropping a file on a different file. Such an arrangement allows the user to make the relation settings between the files by performing an operation in an intuitively easy-to-understand manner, thereby improving the convenience for the user.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

### INDUSTRIAL APPLICABILITY

The present invention provides a technique for managing data with high efficiency.

1. A data management apparatus comprising:
a reception unit which receives a data registration request;
a condition holding unit which stores a condition under which attribute information is to be assigned to the data;
an attribute assignment unit which assigns the attribute information to the data under the condition held by the condition holding unit; and
a registration unit which stores the data in a data holding unit, and which registers the attribute information with respect to the data in a database.

2. A data management apparatus according to claim 1, wherein the attribute information includes a common attribute which is to be assigned to all the data and a customized attribute which can be assigned as desired.

3. A data management apparatus according to claim 1, wherein the condition can be set in increments of directories stored in said data holding unit.

4. A data management apparatus according to claim 1, further comprising:
a form information reception unit which displays an input form including a plurality of data items in a predetermined format, and which receives data input via the input form;
a form information registration unit which registers the data, thus input via the input form, in a form information database such that it is associated with the data items; and
a form information search unit which receives a search condition with respect to the data items, and which extracts from said form information database the data matching the search condition.

5. A terminal apparatus comprising:
a tree display control unit which acquires information which defines a hierarchical structure for classifying, in a hierarchical manner, data stored in a data management apparatus which manages data, and displays the hierarchical structure thereof; and
a list display control unit in which, when a node in the hierarchical structure is selected, a request is made to said data management apparatus to search for data included in a class that corresponds to the node so as to acquire search results, and the search results thus acquired are displayed in the form of a list.

6. A terminal apparatus according to claim 5, wherein said list display control unit acquires information from said data management apparatus with respect to a plurality of attributes assigned to the data included in the aforementioned class, receives information with respect to two attributes selected according to an instruction from among the information with respect to the plurality of attributes, and displays a map in which the data is plotted with the attribute information thus specified respectively set as a vertical axis and a horizontal axis.

7. A terminal apparatus according to claim 6, wherein said list display control unit displays a map in which the data is plotted with the value or the count value of the attribute information thus specified set as the vertical axis or the horizontal axis.

8. A terminal apparatus according to claim 5, wherein said list display control unit acquires information from said data management apparatus with respect to a plurality of attributes assigned to the data included in the aforementioned class, receives the attribute information which is to be set as an index of a graph and which is selected according to an instruction from among the information with respect to the plurality of attributes, and displays a graph in which the data is plotted with the attribute information thus specified set as the index.

9. A terminal apparatus according to claim 8, wherein said list display control unit displays a graph in which the data is plotted with the value or the count value of the attribute information thus specified set as the index of the graph.
